(19) United States
(12) Patent Application Publication
(10) Pub. No.: US 2017/0342940 A1
(43) Pub. Date: Nov. 30, 2017

(54) METHOD OF UTILIZING A COMBINED HEAT AND POWER SYSTEM TO PRODUCE ELECTRICITY FOR A WHOLESALE ELECTRICITY MARKET

(71) Applicant: Scuderi Group, Inc., West Springfield, MA (US)

(72) Inventors: Salvatore Scuderi, Westfield, MA (US); Nicholas Scuderi, Agawam, MA (US)

(73) Assignee: Scuderi Group, Inc., West Springfield, MA (US)

(21) Appl. No.: 15/602,960

(22) Filed: May 23, 2017

Related U.S. Application Data
(60) Provisional application No. 62/341,029, filed on May 24, 2016.

(51) Int. Cl. F02G 5/00; H02K 7/18

(52) U.S. Cl. CPC F02G 5/00; H02K 7/1807

(57) ABSTRACT

A method includes installing a CHP system to be operated by an operator. The operator becomes qualified as a market participant in a wholesale electricity market. An electrical output generated from the CHP system is connected to a first conductive path, the first conductive path operatively conducting power and energy to a grid for sale into the wholesale electricity market. Waste heat generated from the CHP system is utilized to provide one of a product and a process. An efficiency of the waste heat and an electrical efficiency of the electrical output are combined to attain an overall CHP system efficiency of 60 percent or greater.

### CROSS REFERENCE TO RELATED APPLICATIONS

This application claims benefit of priority to U.S. Provisional Application No. 62/341,029 filed May 24, 2016 and entitled “METHOD OF UTILIZING A COMBINED HEAT AND POWER SYSTEM TO PRODUCE ELECTRICITY FOR A WHOLESALE ELECTRICITY MARKET,” which is hereby incorporated by reference in its entirety.

### TECHNICAL FIELD

The present invention relates to the sale of electricity to the wholesale electric markets. More specifically, the invention relates to utilizing a combined heat and power system to produce electricity to the wholesale electricity markets.

### BACKGROUND

Combined Heat and Power (CHP), also known as “cogeneration”, is the simultaneous production of two or more useful forms of energy from a single fuel consuming device. A CHP system is typically an on-site electricity generation system, which captures the heat that would otherwise be wasted to provide useful thermal energy (such as steam or hot water) that can be used for space heating, cooling, domestic hot water and other industrial processes. In this way, a CHP system can achieve overall efficiencies of over 80 percent, compared to 35 percent or greater for conventional grid supplied electricity from a utility. To qualify as a CHP system that can receive federal, state and local incentives such as investment tax credits, accelerated depreciation, and alternative energy credits the overall system efficiency must typically be 60% or higher.

Problematically, most prior art CHP systems are sized to meet the heat load requirements of an on-site application and only partially meet the electricity load requirements of the same application. Since the electricity generated is only secondary to the heat produced, the electrical efficiency of the system is not a primary design consideration. Therefore most prior art CHP systems have electrical efficiencies in the 30% and lower range and in fact many are below 25% efficiency. As a result of low electrical efficiency, it is very difficult for most CHP systems to sell electricity competitively into the wholesale electricity markets. In addition, most CHP systems are owned by an end-user such as hotels or hospitals which typically do not have the knowledge or experience required to participate in a complex market like the electrical wholesale industry.

Accordingly, there is a need for a method of utilizing a combined heat and power system to produce electricity for the wholesale electricity markets. Additionally, there is a need for a method and system of producing electricity for the wholesale electricity markets at electrical efficiencies of greater than 35% wherein the system simultaneously utilizes heat energy to provide a secondary product such that the overall system efficiency is 60% or greater.

### BRIEF DESCRIPTION

The present invention offers advantages and alternatives over the prior art by providing a method of utilizing a CHP system to produce electricity for the wholesale electricity markets. The operator of the CHP system is qualified as a market participant in the wholesale electricity market. The CHP system has an overall system efficiency of 60 percent or greater and an electrical efficiency of 35 percent or greater. The CHP system also utilizes waste heat to provide a product or process.

A method in accordance with one or more aspects of the present invention includes installing a CHP system to be operated by an operator. The operator becomes qualified as a market participant in a wholesale electricity market. An electrical output generated from the CHP system is connected to a first conductive path, the first conductive path operatively conducting power and energy to a grid for sale into the wholesale electricity market. Waste heat generated from the CHP system is utilized to provide one of a product and a process. An efficiency of the waste heat and an electrical efficiency of the electrical output are combined to attain an overall CHP system efficiency of 60 percent or greater.

### DRAWINGS

The invention will be more fully understood from the following detailed description taken in conjunction with the accompanying drawings, in which:

FIG. 1 is a schematic diagram of a CHP system in accordance with the present invention.

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

### GLOSSARY

For purposes of clarity the following words and phrases shall be defined herein as follows:

“Combined Heat and Power” (CHP), also known as “cogeneration”, is the simultaneous production of two or more useful forms of energy from a single fuel consuming device.

“Compressed Air Energy Storage” (CAES) is a way to store energy generated at one time for use at another time using compressed air.

“Distributed Power” or “Distributed Power Generation” is the process of generating power and energy on-site at the point of consumption. Distributed power is supplied directly to an end user, such as a host, without being transmitted through a local utility. A provider which provides solely distributed power generation is not a market participant in the wholesale electricity markets and does not have to execute a generator interconnection agreement with a utility.

“Governmental Authority” means any federal, state, regional, county, town, city, or municipal government, whether domestic or foreign, or any department, agency, bureau, or other administrative, regulatory or judicial body of any such government.

“Grid” means an interconnected network for delivering electricity from electric suppliers to electric consumers. It typically includes generating stations that produce electrical power and energy, high-voltage transmission lines that carry power and energy from distant sources to demand centers, and distribution lines of utilities that connect individual customers (or consumers). A grid is generally a bulk electric power and transmission line system, which usually services a particular geographic area, such as New England.

“Host” is a person or entity having an ownership interest or leasehold interest in a property upon which a provider of electric power and energy installs a system for generating electric power and energy to the host.

“Load” or “Electric Load” is an electrical component, system of electrical components or portion of a circuit that consumes electric power and energy.

“Market Participant” means a person or entity that participates in the wholesale electricity markets. A market participant must have successfully completed a membership process with the administrator of the regional wholesale electricity markets, such as an ISO, RTO or similar, and have signed an agreement with the administrator, typically known as a market participant service agreement, which details the qualifications, responsibilities and obligations required for participating in the wholesale electricity markets. By way of example, one such typical obligation of a market participant is to agree to adhere to a financial assurance policy set by the administrator, which ensures that all market participants are in a good financial position and will not cause undue risk to the wholesale electricity markets.

“Peak Shaving” or “Peak Shave” is the process of reducing the amount of energy purchased, and therefore the amount of costs incurred, from the local utility. Peak shaving is typically done during peak hours when the charges from the utility are highest.

“Split-Cycle Engine” is an engine having a crankshaft rotatable about a crankshaft axis and also having a compression piston slidably received within a compression cylinder and operatively connected to the crankshaft such that the compression piston reciprocates through an intake stroke and a compression stroke during a single rotation of the crankshaft. The split-cycle engine additionally includes an expansion (power) piston slidably received within an expansion cylinder and operatively connected to the crankshaft such that the expansion piston reciprocates through an expansion stroke and an exhaust stroke during a single rotation of the crankshaft. Additionally, the split-cycle engine includes a crossover passage interconnecting the compression and expansion cylinders. The crossover passage including at least a crossover expansion (XovrE) valve disposed therein, but more preferably including a crossover compression (XovrC) valve and a crossover expansion (XovrE) valve defining a pressure chamber therebetween. Several types of split-cycle engine technologies are described in U.S. Pat. No. 6,952,923 filed on Jun. 9, 2004, U.S. Pat. No. 8,677,953 filed on Mar. 14, 2011, U.S. patent application Ser. No. 14/543,223 filed on Nov. 17, 2014 and U.S. provisional patent No. 62/120,770 filed on Feb. 25, 2015, all of which are herein incorporated by reference in their entirety.

“Split-Cycle Engine Expander” or “Split-Cycle Expander” is essentially a stand-alone version of the expansion (or combustion) portion of a split-cycle engine. That is, a split-cycle expander includes an expansion cylinder having an expansion piston reciprocally disposed therein. A connecting rod typically couples the expansion piston to a crankshaft. The top of the expansion cylinder is closed by a cylinder head having an intake valve and an exhaust valve disposed therein, usually along with a fuel injector and an ignition device, such as a spark plug. (In embodiments in which diesel fuel is used, the ignition device can be omitted and compression ignition can be used to initiate combustion.) The intake valve controls fluid communication between a source of compressed air (such as, an air storage tank or a separate compressor) and the expansion cylinder. The exhaust valve controls fluid communication between the expansion cylinder and an exhaust passage. Split-cycle expander technologies are described in U.S. patent application Ser. No. 14/543,223 filed on Nov. 17, 2014 and U.S. provisional patent No. 62/120,770 filed on Feb. 25, 2015, both of which are herein incorporated by reference in their entirety.

“Utility” or “Local Utility” means the local electric distribution company that provides electric transmission and distribution services to end users. A utility typically controls the local distribution facilities of the grid and transmits electric power and energy from electric suppliers to end users through those local distribution facilities.

“Wholesale Electricity Market” means a market through which electric energy, capacity resources and/or other electrical resources are transmitted, bought and/or sold for ultimate distribution to the public. Typically wholesale electricity markets are designed and administered by an Independent System Operator (ISO), such as ISO-New England, which is authorized by the Federal Energy Regulatory Commission (FERC) to oversee the operation of New England's bulk electric power and transmission line system, i.e., New England's electrical grid.

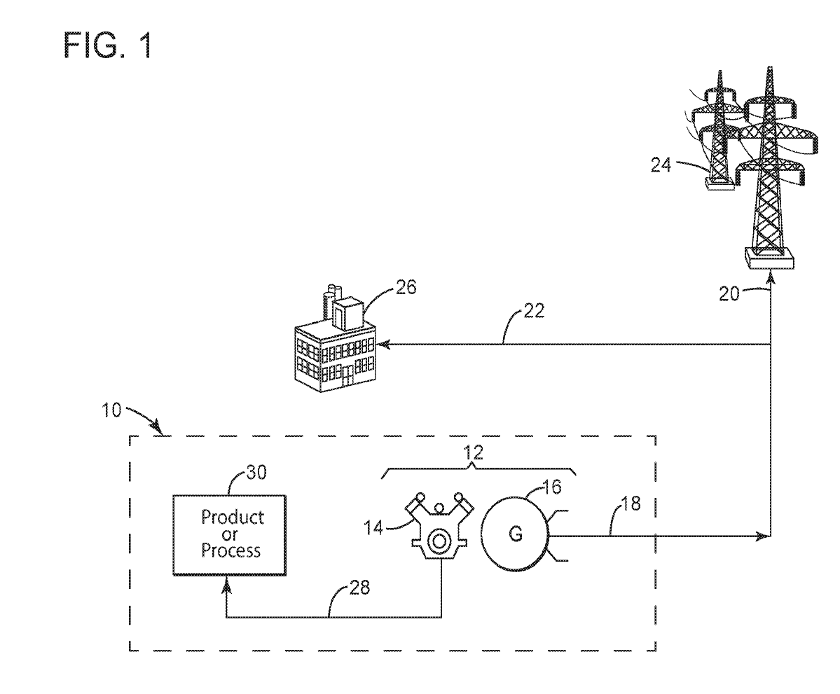

FIG. 1 illustrates an exemplary embodiment of a CHP system in accordance with the present invention.

Referring to FIG. 1, an exemplary embodiment of a CHP system and method of operating in accordance with the present invention is presented at 10. The CHP system 10 is operated by an operator who is a market participant qualified to sell electric power to the wholesale electricity markets.

The CHP system 10 includes a generator system 12. The generator system 12 can include anyone of, or combination of, a number of power generation technologies. For example, the generator system 12 may include natural gas or diesel turbine generators, which have rated power outputs that can reach well over 10 megawatts. The system 12 may also include reciprocating natural gas generators of a type similar to a General Electric Jenbacher part number JMS 624, which has an output rated at approximately 4.3 megawatts. Additionally system 12 may include one or more absorption chillers. Renewable power generation technologies may also be used such as wind, solar or hydro power generators.

The generator system 12 may also include a number of split-cycle engine technologies (for example, a split-cycle-engine or a split-cycle-expander) such as the type described in U.S. Pat. No. 6,952,923 filed on Jun. 9, 2004 and U.S. Pat. No. 8,677,953 filed on Mar. 14, 2011, both of which are herein incorporated by reference in their entirety. The generator system 12 may also include a number of compressed air energy storage (CAES) technologies such as the type described in U.S. patent application Ser. No. 15/138,543, filed on Apr. 26, 2015 and titled: “Method of Providing Electric Power to a Host”, which is herein incorporated by reference in its entirety.

It is important that the generator system 12 have an electrical efficiency that is high enough to be competitive in the wholesale electricity markets. Generally, this means that an electrical efficiency of generator system 12 (usually the electrical efficiency measured at full load conditions) should be 35 percent or higher. More preferably, the electrical efficiency should be 40 percent or higher. Most preferably, the electrical efficiency should be 50 percent or higher.

In the specific exemplary embodiment of FIG. 1, the generator system 12 includes an engine 14 which drives a generator 16 to produce an electric power output 18 connected to a first conductive path 20 and optionally connected to a second conductive path 22. As mentioned earlier, in order to competitively sell into the wholesale electricity markets, it is highly desirable that the electrical efficiency of the electric output 18 is 35 percent or greater. More preferably, however, the electrical efficiency should be 40 percent or greater. Most preferably, the electrical efficiency should be 50 percent or greater.

The first conductive path 20 connects the electric power output 18 of the CHP system 10 to the grid 24 (most likely at a local utility's substation (not shown) or other local grid distribution facility controlled by the utility) to provide electrical power and energy to the wholesale electricity markets. The second conductive path 22 is optional and may connect a portion of the electric power output 18 to an on-site facility 26 (such as a school, factory, a home or the like) without connecting to the grid.

The facility 26 may be operated by a host, which has an ownership interest or a leasehold interest in the property that the CHP system 10 is located. As such, the CHP system can provide a variety of benefits to the host, such as distributed power, peak shaving and backup generator power in case of a power outage on the grid.

The CHP system additionally utilizes waste heat 28 from the engine 14 to produce an additional product or process 30. Such a product could be any item that requires heat in its manufacturing processes to produce the product. Two examples of such products are distilled water and ethanol. Such a process may be heating or cooling a facility such as, for example, the facility 26 illustrated in FIG. 1.

The amount of waste heat 28 utilized from engine 14 is sized to result in an overall system 10 efficiency of at least 60%, more preferably at least 70% and most preferably at least 80%. This results in the system 10 qualifying as a CHP system eligible for government incentives such as tax credits, accelerated depreciation and alternative energy credits. In addition, the product or process 30 provides another revenue stream that helps to increase the system's 10 overall cash flow and profitability.

The unique features of the CHP system and method 10 are;
1. Designed for high electrical efficiency of 35 percent, 40 percent, 50 percent or greater to be able to competitively participate in the wholesale electricity markets.
2. Provides a product or process where waste heat 28 can be effectively utilized to provide an additional income stream for the operator of the CHP system.
3. Meets regulatory requirements to be classified as a CHP system that qualifies for all federal, state, and local incentives (e.g., 60% or greater overall system efficiency).
4. Preferably the CHP system has an overall efficiency of 70 percent or greater and most preferably 80 percent or greater.
5. The CHP system 10 being operated by an operator that is a market participant qualified to sell into the wholesale electricity markets.
6. Unlike most market participants in the wholesale electricity markets, the operator of the CHP system can qualify for federal, state and local incentives, such as investment tax credits, accelerated depreciation, alternative energy credits and the like, which have been provided by a Government Authority by virtue of the system 12 being recognized as a combined heat and power system by that Government Authority.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

1. A method comprising:
installing a combined heat and power (CHP) system to be operated by an operator;
connecting an electrical output generated from the CHP system to a first conductive path, the first conductive path operatively conducting power and energy to a grid for sale into the wholesale electricity market;
utilizing waste heat generated from the CHP system to provide one of a product and a process; and
combining an efficiency of the waste heat and an electrical efficiency of the electrical output to attain an overall CHP system efficiency of 60 percent or greater,
wherein the operator is qualified as a market participant in a wholesale electricity market.

2. The method of claim 1 comprising:
connecting the electrical output generated from the CHP system to a second conductive path, the second conductive path connecting a portion of the electrical power output to a facility without connecting to the grid.

3. The method of claim 2 wherein the facility is one of a school and a factory and a home.

4. The method of claim 1 comprising:
utilizing the waste heat from the CHP system to provide one of a process of cooling and a process of heating to a facility.

5. The method of claim 1 comprising:
utilizing the waste heat from the CHP system to produce one of a product of distilled water and ethanol.

6. The method of claim 1 comprising:
generating the electrical output at an electrical efficiency of 35 percent or greater.

7. The method of claim 1 comprising:
generating the electrical output at an electrical efficiency of 40 percent or greater.

8. The method of claim 1 comprising:
generating the electrical output at an electrical efficiency of 50 percent or greater.

9. The method of claim 1 comprising:
combining the efficiency of the waste heat and the electrical efficiency of the electrical output to attain an overall CHP system efficiency of 80 percent or greater.

10. The method of claim 1 comprising:
installing a CHP system having a generator system which incorporates one of a split-cycle engine and a split-cycle expander.

11. The method of claim 1 comprising:
selling electricity generated by the CHP system to the wholesale electricity markets; and
qualifying for incentives provided by a Government Authority by virtue of the system being recognize as a combined heat and power system by that Government Authority.
